(19) United States
(12) Patent Application Publication
(10) Pub. No.: US 2024/0198258 A1
(43) Pub. Date: Jun. 20, 2024

(54) PUMP STRAINER WITH PNEUMATIC CLEANING

(71) Applicant: MOUNTAIN ROAD TRADING PTY LTD., New South Wales (AU)

(72) Inventors: Anthony Higgins, New South Wales (AU); Tyler Creagh, New South Wales (AU)

(21) Appl. No.: 18/023,790

(22) PCT Filed: Jun. 30, 2021
(86) PCT No.: PCT/AU2021/050697

§ 371 Date: Feb. 28, 2023

(30) Foreign Application Priority Data
Jul. 1, 2020 (AU) 2020902241

(51) Int. Cl. B01D 29/64; B01D 29/44; F04D 29/70

(52) U.S. Cl. CPC B01D 29/6438; B01D 29/445; F04D 29/708

(57) ABSTRACT

The present invention provides a strainer for use with a water pump in a mine that includes a grill for preventing the ingress of solid material over predetermined dimensions, and an air discharge structure positioned so as to produce a continuous flow of air to remove the material from at least part of the grill, so that flow is maintained through the strainer.

### TECHNICAL FIELD

The present invention relates to pump strainers for water pumps.

### BACKGROUND OF THE INVENTION

In many applications, water is required to be pumped from a location via an intake conduit. This may be a body of water, for example water to be drained from a mine or other cavity. The water may contain material of a size which would be damaging to the pump, either to the impellers or pump mechanism, or of a size to obstruct or block the pump intake.

In such application, it is common to use a device called a strainer. A strainer is structure used to prevent the ingress of particulates over a certain size, so as to avoid the pump inlet being blocked. The dimensions of the strainer and its material will vary with the application. Generally, strainers are directed at relatively large particulates and other debris. The strainer will, over time, become obstructed or clogged with material, as the pump draws in and retains the material on the surface of the strainer. This is turn will over time limit the flow into the pump. The problem that a strainer addresses is not to divide different sizes of material or particles, but simply to prevent to keep the pump operating in an environment where debris may cat to clog the intake.

A conventional approach used with pump strainers is to manually clean them periodically, using tools such as a shovel. The frequency of this will of course depend upon the level of material in the water which is to be pumped. This is also dependent on the diligence of the operators. However, delay or lack of diligence in this process can result in pumps becoming completely blocked and damaged, or shutting down for lack of water.

Another approach to clean a strainer is using a pressurised cleaning fluid. For example, U.S. Pat. No. 6,554,138 B1 by DISA A/S discloses a device for cleaning the filter surface of a filter element, through which the liquid to be filtered flows, during a filtration operation using a pressurised cleaning fluid.

It is an object of the present invention to provide an improved strainer and method of operating a strainer which require less manual cleaning than conventional strainers.

### SUMMARY OF THE INVENTION

In a first broad form, the present invention provides a strainer with an associated pneumatic cleaning outlet, so that in use pressurised air removes material from the outside of the strainer.

According to one aspect, the present invention provides a strainer for use with a water pump that includes a grill for preventing the ingress of solid material over predetermined dimensions, and an air discharge structure positioned so as to produce a flow of air to remove the material from at least part of the grill, so that flow is maintained through the strainer. The pump has particular utility in a mine. It is preferably adapted to use continuous air flow.

According to another aspect, the present invention provides a method for maintaining a flow of water through a strainer, the strainer being operatively attached to a pump to prevent the ingress of solid material over predetermined dimensions, the method including at least the steps of: providing an air discharge structure on the strainer positioned so as to produce a flow of air; and generating a flow of air from the structure so as to remove the material from at least part of the grill; such that the flow of water to the pump is maintained.

The present invention also encompasses pumps which include a strainer as described.

### BRIEF DESCRIPTION OF THE DRAWINGS

Illustrative embodiments of the present invention will now be described with reference to the accompanying figures, in which:

FIG. 1 is a perspective view of a first implementation of a strainer according to the present invention;

FIG. 2 is a side view of the strainer of FIG. 1; and

FIG. 3 is a front perspective view of the air discharge structure of FIG. 1 in an open configuration.

### DETAILED DESCRIPTION OF THE INVENTION

The present invention will be described with reference to particular implementations. It should be understood that the implementations discussed are purely illustrative, and are in no way limitative of the scope of the inventions disclosed. Various inventive features are disclosed, and it will be understood that this disclosure includes them in the combination as discussed, as well as their individual integers and in sub combinations.

The term water is used broadly in the context of the present invention. It is not limited to water alone but it also encompasses other liquids, for example slurries and solutions, carrying materials and debris.

It will also be understood that if exhaust air is used, for example from the pneumatic pump motor, that this will generally be pulsatile in nature. For the purposes of this specification and claims, it will be understood that continuous encompasses pulsatile flows during the continuing operation of the pump. It will be understood that the volume, pressure and flow rate required will be dependent on the specific application, and may need to be adjusted in use to optimise efficiency.

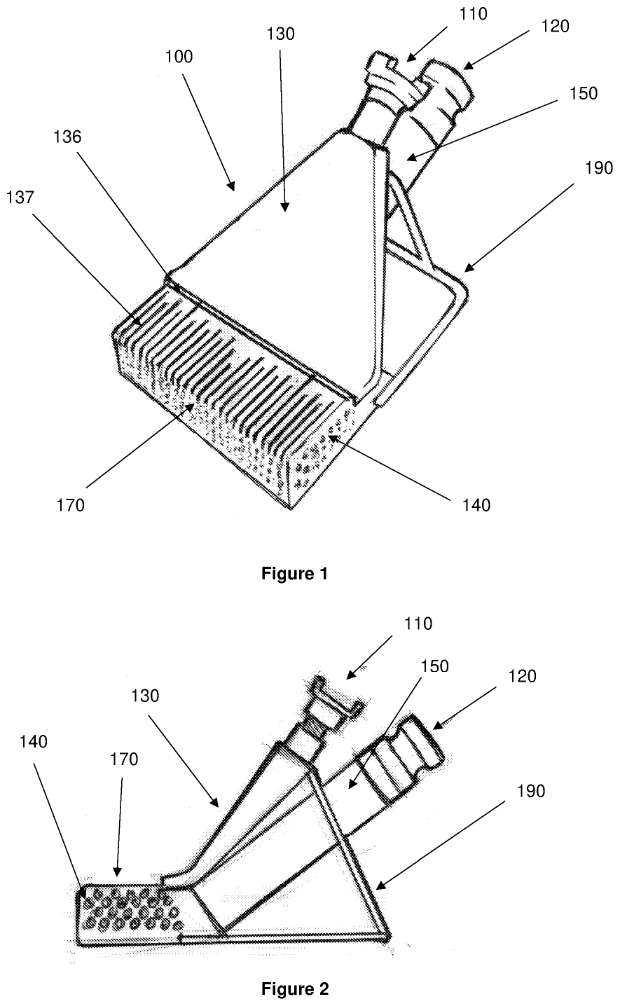

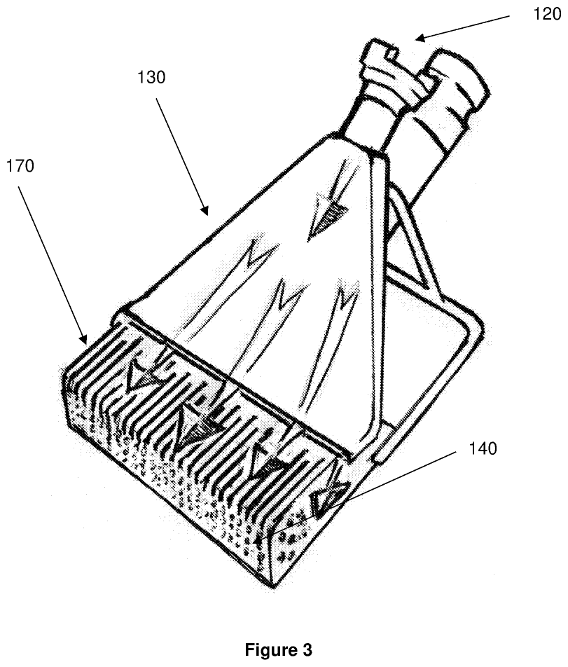

FIGS. 1 and 2 illustrate a first implementation of a strainer 100 according to the present invention. The strainer 100 has a suction pipe 150, a grill 170, an air discharge structure 130 and a support structure 190.

The suction pipe 150 has a coupling 120 to facilitate the connection between the suction pipe 150 and a pump (not shown). The pump would be any types of pump that can pump out water from one location to another location. For example, any compressed air driven diaphragm pump could be used, such as Wilden® and Pumps 2000®.

At end of suction pipe 150, a grill 170 is located to prevent the ingress of solid material over predetermined dimensions. The grill 170 has a plurality of openings 140 positioned across the faces of the grill 170. The openings 140 can be of any suitable shape or size, depending on the quality of water required for the pump to operate effectively in a given situation. The illustrated grill 170 has a typical dimension of 200 mm×75 mm×50 mm.

As shown in FIGS. 1 and 2, the air discharge structure 130 is substantially triangular in shape with a triangular cross section. The body of the air discharge structure 130 is transitioned to the air outlet 136 via a curved edge. The air discharge structure 130 is positioned in the periphery of the grill 170 so as to produce a continuous flow of air to remove materials from at least part of the grill so that flow is maintained through the strainer. The air discharge structure 130 has an air line coupling 110 for attachment to a source of pressurised air (not shown) for example a pneumatic system. The air discharge structure 130 produces a continuous flow of air with the use of a pneumatic valve (not shown) to control or modulate the flow of air. The air discharge structure 130 may also have a rope hanging lug 135 (not shown) positioned at the top of the structure.

As shown in FIG. 1, the grill 170 has a plurality of slots or compartments 137. These compartments have different sizes which would assist the air from the air outlet 136 to form a turbulent flow. This turbulent state of the air would help to efficiently remove materials from the grill 170.

As shown in FIG. 3, the flow of air is directed across the grill from the outside of the grill. It should be noted that the position of the air discharge structure 130 is not limited in the periphery of the grill 170 and should be taken broadly that it can be positioned across the faces of the grill 170.

The pressurised air may be provided to the coupling 110 in any suitable way. For example, where a pneumatic pump is used, as it common in a mining environment, the exhaust air from the pump may be used. An existing pressurised air system in a mine or other location may be used. In other applications, a compressor or similar device could be used, or the exhaust gases from an engine powering a pump. It will be appreciated that any suitable source of air (or potentially other gases) at a sufficient pressure may be used to effect the strainer cleaning process as described.

One of the advantages of the strainers 100 is that they do not require periodic manual cleaning because the air flow in the air discharge structure is continuous. Hence, the build up of debris in the grill 170 is prevented so that the flow of water is maintained through the strainers 100. Since manual cleaning of strainers 100 is reduced, the implementations of the present invention also reduce downtime.

It will be understood that the examples described relate to specific strainer structures, and that alternative implementations suitable for other strainers are also contemplated within the scope of the present invention. The air flow may proceed from outside the strainer as illustrated, or may flow from inside the strainer to the outside to dislodge material in some alternative implementations.

Moreover, suitable implementations of the present invention would also assist in preventing pumps from being damaged, since blockage of the strainer is prevented or at least minimised.

The implementations of the present invention can be used not only for water pumps used in mines but also for any types of pump in various applications wherein a liquid is required to be pumped out to another location.

1. A strainer for use with a water pump, including a grill for preventing the ingress of solid material over predetermined dimensions, and an air discharge structure positioned so as to produce a continuous flow of air to remove the material from at least part of the grill, so that flow is maintained through the strainer.

2. A strainer according to claim 1, further including a connection means for attachment to a source of pressurised air.

3. A strainer according to claim 1 or claim 2, wherein the flow of air is generated by the exhaust from a pneumatic pump or motor.

4. A strainer according to claim 1, wherein the flow of air is directed across the grill from outside the grill.

5. A strainer according to claim 1, wherein the flow of air is directed generally across a surface of the grill.

6. A strainer according to claim 1, wherein the strainer includes a generally planar grill surface including a series of slots, the slots being aligned generally parallel to the direction of air flow.

7. A strainer according to claim 6, wherein the slots have different lengths, so as to enhance the effect of the air flow in clearing the solid material from the strainer.

8. A method for maintaining a flow of water through a strainer, the strainer being operatively attached to a pump to prevent the ingress of solid material over predetermined dimensions, the method including at least the steps of:
providing an air discharge structure on the strainer positioned so as to produce a continuous flow of air;
Generating a flow of air from the structure so as to remove the material from at least part of a grill;
such that the flow of water to the pump is maintained.

9. A method according to claim 8, wherein the flow of air is generated by the exhaust from a pneumatic pump or motor.

10. A method according to claim 8 or 9, wherein the flow of air is directed across the grill from outside the grill.

11. A method according to claim 8, wherein the flow of air is directed generally across a surface of the grill.

12. A method according to claim 8, wherein the strainer includes a generally planar grill surface including a series of slots, the slots being aligned generally parallel to the direction of air flow.

13. A method according to claim 12, wherein the slots have different lengths, so as to enhance the effect of the air flow in clearing the solid material from the strainer.

14. A pump including a strainer according to claim 1.

15. A pump including a strainer operatively adapted to carry out the method of claim 8.
